(19) United States
(12) Patent Application Publication
(10) Pub. No.: US 2023/0365381 A1
(43) Pub. Date: Nov. 16, 2023

(54) DOUBLE WIRE LIP HOOK

(71) Applicant: Timberline Helicopters Inc, Sandpoint, ID (US)

(72) Inventor: Brian Jorgenson, Sandpoint, ID (US)

(73) Assignee: Timberline Helicopters Inc, Sandpoint, ID (US)

(21) Appl. No.: 18/104,733

(22) Filed: Feb. 1, 2023

Related U.S. Application Data
(60) Provisional application No. 63/306,080, filed on Feb. 2, 2022.

(51) Int. Cl. B66C 1/34; F16L 1/00; H02G 1/04

(52) U.S. Cl. CPC B66C 1/34; F16L 1/00; H02G 1/04

(57) ABSTRACT

A double wire lip hook is provided. The double wire lip hook may be used for electrical power line work by helicopter or crane, in which closely spaced pairs of wires are used. The double wire lip hook may also be used for single wires and other lifting and pulling tasks. The example double wire lip hook has a geometry designed for high strength, maintaining a substantial cross-sectional area of metal or alloy throughout its profile. The double wire lip hook provides dual opposing hooks with wide throats cambered for wires. Dual tapers in a vertical shank member provide a large gape opening for each hook and keep loads on either side close to the vertical lifting axis for improved stability. Features such as one or more support ribs add to lifting strength and resistance to yield failure.

### BACKGROUND

Utility helicopters lift and pull a variety of external loads depending on industry and locale. More and more electrical line work is performed using helicopters. Helicopters also provide lift for construction, firefighting, logging, fertilizing crops, tree harvesting, oil and gas work, agriculture, and tree trimming.

### SUMMARY

A double wire lip hook is provided. The double wire lip hook may be used for electrical power line work by helicopter or crane, in which closely spaced pairs of wires are used. The double wire lip hook may also be used for single wires and other lifting and pulling tasks. The example double wire lip hook has a geometry designed for high strength, maintaining a substantial cross-sectional area of metal or alloy throughout its profile. The double wire lip hook provides dual opposing hooks with wide throats cambered for wires. Dual tapers in a vertical shank member provide a large gape opening for each hook and keep loads on either side close to the vertical lifting axis for improved stability. Features such as one or more support ribs add to lifting strength and resistance to yield failure.

This summary is not intended to identify key or essential features of the claimed subject matter, nor is it intended to be used as an aid in limiting the scope of the claimed subject matter.

### BRIEF DESCRIPTION OF THE DRAWINGS

FIG. 1 is a diagram of an example double wire lip hook.

FIG. 2 is a diagram of various different views of the example double wire lip hook of FIG. 1.

FIG. 3 is a diagram of the example double wire lip hook, showing multiple features.

### DETAILED DESCRIPTION

This disclosure describes a double wire lip hook. The double wire lip hook may be used for installation, maintenance, repair, and overhaul of electrical power lines by helicopter or crane. The double wire lip hook may also be used for other lifting, pulling, and hoisting tasks in various other industries.

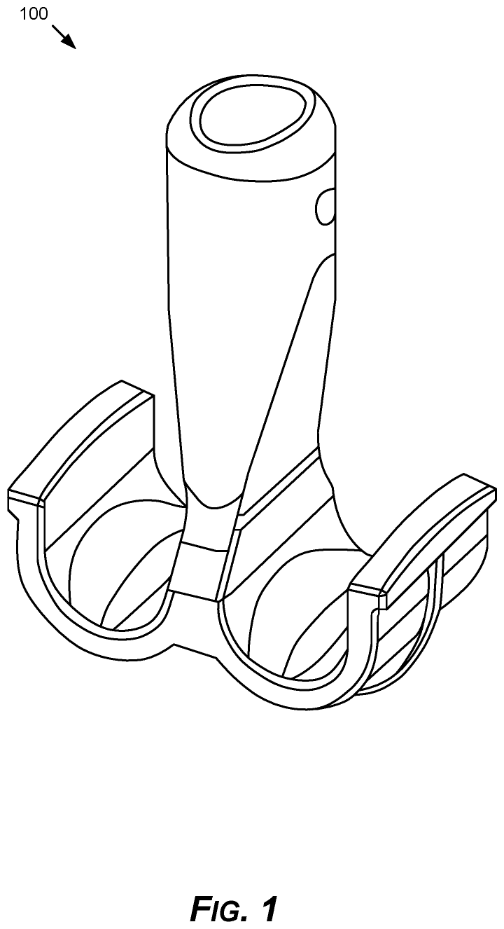

FIG. 1 shows an example implementation of the double wire lip hook 100. The example double wire lip hook 100 may be used for electrical line work as introduced above. Electrical power lines are often deployed as a closely spaced pair of wires: each leg of a given high-voltage electrical transmission circuit being allotted a respective pair of wires. Advantageous features of the double wire lip hook 100 for placing and servicing such wire pairs are described below.

Example implementations of the double wire lip hook 100 may also be used for tasks in other industries, such as in the oil and gas industry, construction, firefighting, and logging, for example. Example embodiments of the double wire lip hook 100 may hoist and position pipes, hoses, cables, fiber optics, bundled loads, and individual parts, for example. The double wire lip hook 100 may efficiently lift and pull items bound or bundled to provide two cable handles, such as trees bound with one or more cables, bundled logs, rocks, tanks, Bambi Buckets for fighting fires, and so forth. The double wire lip hook 100 may also lift some items with only one cable handle to grab.

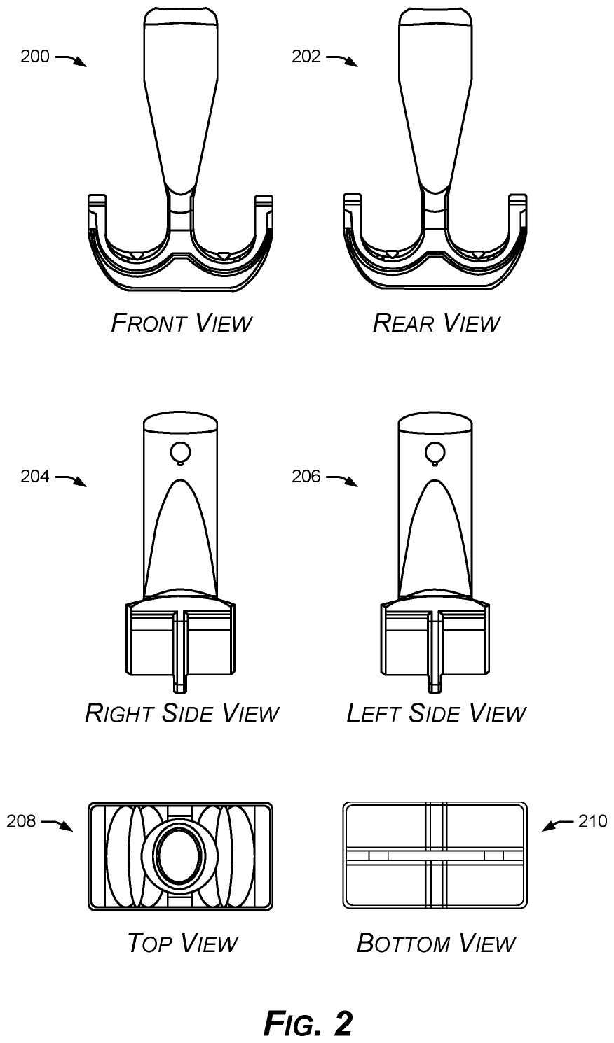

FIG. 2 shows additional views of the example double wire lip hook 100. A front view 200 shows a balanced symmetry of dual hooks. In an implementation, a rear view 202 of the example double wire lip hook 100 looks similar to the front view 200. A right side view 204 reveals that the hooks have a wide throat. In an implementation, a left side view 206 is similar to the right side view 204. A top view 208 shows the profile of the example double wire lip hook 100 from elevation, and a bottom view 210 shows bottom structure of the example double wire lip hook 100.

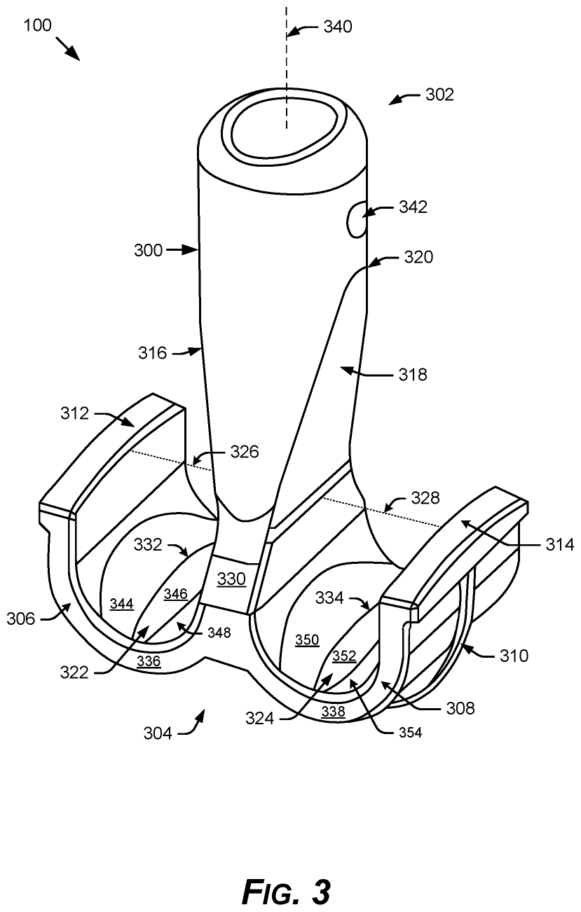

In FIG. 3, the example double wire lip hook 100 has features that provide multiple advantages over conventional helicopter cargo hooks and conventional crane hooks. The example double wire lip hook 100 has a construction geometry designed for enormous strength. Heavy lifts or pulls can impart fatigue and breakage to conventional cargo hooks, especially in industries such as logging. But the example double wire lip hook 100 maintains a substantial cross-sectional area of metal or alloy throughout its profile, from top to bottom.

The example double wire lip hook 100 has a main body, or vertical shank member 300 with a top end 302 and a hook end 304. A first curved hook 306 and a second curved hook 308 are disposed 180 degree apart from each at the hook end 304 of the vertical shank member 300. Thus, the example double wire lip hook 100 has two opposing open hooks, symmetrically placed. This dual arrangement of the open hooks provides several advantages over conventional single cargo hooks and conventional treble hooks. Many high-voltage power line systems for power transmission towers and electricity pylons use double power lines for each leg of a circuit. As introduced above, electrical power lines are often deployed as a closely spaced pair of wires, with each leg of a given high-voltage electrical transmission circuit being allotted a respective pair of wires. The pairs of lines are generally spaced 6-20 inches apart from each other. These doublets or wire pairs are at the same voltage and phase as each other, providing a “single” thick wire for a given leg of the transmission circuit that is split into two thinner wires. It is often easier to install two smaller wires to double the current capacity of a line than to install a single thicker wire. It can also be easier to stock and handle lighter cable. Multiple wires carrying the same leg of a circuit can also provide redundancy if one wire fails. With AC electricity, the current flows mostly near the surface of the wire conductor, so multiple thin wires can provide more conduction area near their surfaces than a single thick wire.

The example double wire lip hook 100 easily grabs and holds pairs of wires, remotely from a helicopter or crane, for power line servicing. Compared to a treble hook, the example double wire lip hook 100 provides a balanced grab and hold for two wires, or even one wire, whereas the conventional treble hook tilts at a significant angle under load with respect to its sling line, grabbing either one or two wires. This conventional shortcoming of treble hooks can be treacherous in some situations, and can also provide an awkward stress on the conventional treble hook.

In an implementation, the bottom of the example double wire lip hook 100 is reinforced with one or more support ribs 310 made of metal or alloy, that runs from a first hook lip 312 of the first curved hook 306, around the bottom, to the opposing second hook lip 314 of the second curved hook 308. In FIG. 3, this extra support rib 310 of metal or alloy provides extra buttressing, strutting, and cross-bracing with respect to the vertical shank member 300 of the example double wire lip hook 100, providing strong resistance against cross-sectional fatigue and yield failure.

In an implementation, the vertical shank member 300 of the example double wire lip hook 100 tapers concavely on each side with a first concave taper 316 and an opposing second concave taper 318, beginning at some vertical distance 320 from the top end 302, where the example double wire lip hook 100 makes physical connection to a helicopter's sling line or underbelly suspension system. The first concave taper 316 and the second concave taper 318 continue down to the first curved hook 306 and the second curved hook 308 on each side of the example double wire lip hook 100 forming respective parts of the first throat 322 of the first curved hook 306 and the second throat 324 of the second curved hook 308. These dual concave tapers 316, 318 provide an increased open space or “gape” 326, 328 between each hook lip 312, 314 and the vertical shank member 300, for grabbing and securing wires, as compared to conventional lift hooks that do not taper in this manner. This maximization of the gapes 326, 328 of the open hooks 306, 308 on each side of the example double wire lip hook 100 due to the dual tapers 316, 318 in the vertical shank member 300 makes it much easier to claw, slip, grab, and/or secure electrical power lines from the vantage point of the helicopter or crane.

The dual tapers 316, 318 of the vertical shank member 300 do not sacrifice the strength of the example double wire lip hook 100 in providing the taper features 316, 318. In an implementation, as the vertical shank member 300 tapers concavely inward toward the open hooks 306, 308 on each side, the vertical shank member 300 also tapers convexly outward 330 on each side, in a plane perpendicular to the crosswise plane of the open hooks 306, 308. These convex tapers 330 provide a greater cross-sectional area of metal or alloy in the vertical shank member 300 in relation to the concave inward dual tapers 316, 318 that decrease the cross-sectional area or “girth” of the vertical shank member 300 in the plane of the open hooks 306, 308. Thus, approximately the same cross-sectional area of metal or alloy remains continuously present down the length of the vertical shank member 300, merely changing cross-sectional shape from top to bottom, but not cross-sectional area, to provide high strength for lifting or pulling with one or both of the open hooks 306, 308.

In an implementation, the double wire lip hook 100 has a large throat base 322, 324 at the bottom of each of the first curved hook 306 and the second curved hook 308. These large throat bases 322, 324 spread the lifting force on a wire or pipe across a greater linear stretch of the wire or pipe being lifted or pulled, thereby decreasing the force per unit area on the section of wire or pipe contacted. A conventional cargo hook can lift with an area of its hook that is so small on the wire being lifted or pulled, that the forces are detrimental to the wire, causing bending or metal fatigue.

The large throat base 322, 324 of each open hook 306, 308 of the double wire lip hook 100 is curved in a natural arc or camber 332, 334 perpendicularly to the overall bends 336, 338 of the respective open hooks 306, 308. This natural arc or camber 332, 334 spares the wire that is being lifted or pulled from the angular stresses caused by the sudden edges and minimal contact surfaces of conventionally narrow cargo hooks and conventional treble hooks. In an implementation, the first throat 322 of the first curved hook 306 and a second throat 324 of the second curved hook 308 each have a width approximately equal to one-third to one-half the length of the vertical shank member 300, with each width curving in the natural arc or camber 332, 334.

When the double wire lip hook 100 is grabbing and securing only one wire, instead of two, the double wire lip hook 100 is designed to remain stable and in position in what would otherwise be an unbalanced situation for conventional treble hooks and the like. The tapers 316, 318 in the vertical shank member 300 also place each secured wire—the load—closer to the vertical axis 340 of the vertical shank member 300, than if there were no tapers 316, 318. This proximity to the vertical axis 340 of the vertical shank member 300 does not allow a wire or other load to gain leverage (or lever arm) for tilting the vertical shank member 300 with respect to the sling line, if one side of the double wire lip hook 100 experiences a greater loading force than the other side.

A pivot pin 342 provides a connection linkage between the double wire lip hook 100 and a sling line or underbelly suspension system cable of a helicopter, for example, the sling line usually following the vertical axis 340 of the double wire lip hook 100. In an implementation, the pivot pin 342 is disposed horizontally near the top end 302 of the vertical shank member 300 and allows the double wire lip hook 100 to pivot only in a direction perpendicular to an unbalanced load on the two hooks 306, 308. This arrangement provides optimum stability when lifting only one wire on one side of the double wire lip hook 100, or when lifting two wires but one of the wires breaks, is dislodged, goes slack, or pulls will less force than the other wire, creating an unbalanced load with respect to the two open hooks 306, 308.

The first throat base 322 and the second throat base 324 may have multiple facets 344, 346, 348 and 350, 352, 354 that direct and secure each wire being lifted or pulled into a single linear channel (e.g., 346, 352) at the bottom of the given throat base 322, 324.

The double wire lip hook 100 can be made from different metals and alloys with high tensile strength and high yield strength depending on intended use, such as a forged alloy steel, grade 80 or grade 100 alloy, steel A36, carbon composites, type 304 or type 316 stainless steel, aluminum 6061-T6, aluminum 5052-H32, aluminum 3003, steel grade 50, titanium, and so forth.

The double wire lip hook 100 may be made in any size. An 8 inch tall example implementation of the double wire lip hook 100 made of suitable material may provide a maximum cargo sling load capacity of 20,000-44,000 lbs for use with military helicopters, although this is overkill for most electrical line work and power line servicing projects. Another implementation of the double wire lip hook 100 may provide a maximum cargo sling load capacity of 20,000+lbs for civilian Sikorsky S-64 Sky Crane electrical line work and other lifting and pulling jobs.

In the description above, it is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning, i.e., they will be taken to mean an inclusion of not only the listed components which the use directly references, but also to other non-specified components elements.

In the foregoing specification, specific embodiments have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A double wire lip hook, comprising:
a vertical shank member having a top end and a hook end opposite the top end;
a first curved hook and an opposing second curved hook at the hook end of the vertical shank member, the first curved hook and the second curved hook disposed linearly 180 degrees apart from each other at the hook end of the vertical shank member;
a dual concave taper of the vertical shank member, the dual concave taper comprising a first concave taper of the vertical shank member facing the first curved hook and a second concave taper of the vertical shank member facing the second curved hook; and
the first concave taper and the second concave taper increasing a gape and a bite of the first curved hook and the second curved hook.

2. The double wire lip hook of claim 1, further comprising a pivot pin at or near the top end of the vertical shank member, the pivot pin to limit pivoting of the double wire lip hook in a plane of the opposing first curved hook and second curved hook with respect to a sling line or connector, the pivot pin allowing pivoting of the double wire lip hook in a plane perpendicular to the opposing first curved hook and second curved hook with respect to a sling line or connector.

3. The double wire lip hook of claim 1, further comprising a first convex taper of the of the vertical shank member perpendicular to the first curved hook and a second convex taper of the vertical shank member disposed linearly 180 degrees apart from the first convex taper, the first and second convex tapers increasing a width of the vertical shank member in a plane perpendicular to the first curved hook and the second curved hook.

4. The double wire lip hook of claim 3, wherein a cross-sectional profile of the vertical shank member maintains approximately a constant cross-sectional area of metal or alloy along the vertical shank member despite the dual concave taper of the vertical shank member and despite the first convex taper and the second convex taper of the vertical shank member.

5. The double wire lip hook of claim 1, wherein a first throat base of the first curved hook and a second throat base of the second curved hook each have a width approximately equal to one-third to one-half the length of the vertical shank member.

6. The double wire lip hook of claim 5, wherein the first throat base of the first curved hook and the second throat base of the second curved hook each have a curved surface for contacting a wire, cord, hose, or pipe to be lifted or pulled.

7. The double wire lip hook of claim 6, wherein the curved surface of each throat base of the first curved hook and the second curved hook each comprise a natural arc or camber in a plane perpendicular to respective bends of the respective first curved hook and second curved hook, the natural arc or camber curving in a direction perpendicular to the respective bends.

8. The double wire lip hook of claim 7, wherein each throat base comprises multiple facets, the multiple facets to direct and secure a wire being lifted or pulled into a single linear channel at a bottom of the given throat base.

9. The double wire lip hook of claim 1, further comprising a support rib running across bottoms of the first curved hook, the second curved hook, and the hook end of the vertical shank member.

10. The double wire lip hook of claim 9, wherein the support rib has a square or rectangular cross-section.
